(19) United States
(12) Patent Application Publication
(10) Pub. No.: US 2016/0101942 A1
(43) Pub. Date: Apr. 14, 2016

(54) CONTAINMENT SYSTEMS AND METHODS WITH REDUCED FRICTION

(71) Applicants: Red Leaf Resources, Inc., South Jordan, UT (US); Total E&P USA Oil Shale, LLC, Houston, TX (US)

(72) Inventor: Sean Hinchberger, South Jordan, UT (US)

(21) Appl. No.: 14/880,845

(22) Filed: Oct. 12, 2015

Related U.S. Application Data
(60) Provisional application No. 62/063,039, filed on Oct. 13, 2014.

(51) Int. Cl. B65G 5/00; E02D 17/20; B65D 90/22; E02D 17/18; E21D 11/00; B09B 1/00

(52) U.S. Cl. CPC B65G 5/00; E21D 11/00; B09B 1/008; B09B 1/004; B65D 90/22; E02D 17/18; E02D 17/202

(57) ABSTRACT

Systems and methods for containing a subsiding solid material. A containment system can include a capsule surrounding a porous volume. The porous volume can contain a porous solid material subject to subsidence oriented within the capsule and supporting the roof of the capsule. The roof of the capsule can include a sloped portion configured to decrease in slope as the solid material subsides. A plurality of geosynthetic layers can be oriented along the sloped portion. The plurality of geosynthetic layers can include at least two adjacent geosynthetic layers that laterally slide with respect to one another during subsidence to reduce shear forces in the sloped roof portion.

### RELATED APPLICATION

This application claims priority to U.S. Provisional Application No. 62/063,039, filed Oct. 13, 2014, which is incorporated herein by reference.

### FIELD OF THE INVENTION

The present invention relates to systems and methods for containing subsiding materials, such as hydrocarbonaceous materials that subside during hydrocarbon extraction. Therefore, the invention relates to the field of hydrocarbon production.

### BACKGROUND

Many processes have been developed for producing hydrocarbons from various hydrocarbonaceous materials such as oil shale and tar sands. Historically, the dominant research and commercial processes include above-ground retorts and in-situ processes. More recently, encapsulated impoundments have been developed for recovering oil from crushed oil shale (In-Capsule® technology). These impoundments are formed primarily of earthen materials, with the crushed oil shale being encapsulated by an impermeable barrier made of rock, soil, clay, and geosynthetics, among other materials. The encapsulated impoundments can be very large, sometimes occupying several acres. The crushed oil shale is heated to convert kerogen in the oil shale into liquid and gaseous hydrocarbons that can then be extracted. The extracted hydrocarbons represent lost mass from the crushed oil shale, and a corresponding loss in overall volume of the crushed oil shale. In some cases, this can cause particles of the crushed oil shale to settle and subside which can create difficulties with respect to maintaining integrity of encapsulation barriers and walls.

### SUMMARY

The present technology provides containment systems and methods for containing subsiding materials. In one aspect, a containment system can include a capsule surrounding a porous volume. A porous solid material subject to subsidence can be oriented within the capsule and can support a roof of the capsule. The roof of the capsule can include a sloped roof portion configured to decrease in slope as the solid material within the capsule subsides. A plurality of geosynthetic layers can be oriented along at least portions of the sloped roof portion. The plurality of geosynthetic layers can include at least two adjacent geosynthetic layers that laterally slide with respect to one another during subsidence to reduce shear forces within the sloped roof portion.

In another aspect, a method of reducing shear forces within a containment system for particulate materials subject to subsidence can include depositing a body of particulate materials subject to subsidence. The method can also include forming a capsule surrounding the body of particulate material subject to subsidence. This can include forming at least one sloped cap section supported from underneath by the body of particulate materials subject to subsidence. The sloped cap section can be at least partially made up of a deformable material having at least one plurality of geosynthetic layers configured to slide sufficient to relieve shear forces during subsidence of the body of particulate material.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1A is a cross-section illustration of a containment system in accordance with an embodiment of the present technology;

FIG. 1B is a close-up view of a segment of a sloped roof portion in accordance with an embodiment of the present technology;

FIG. 2 is a top plan view of a containment system in accordance with an embodiment of the present technology;

FIG. 3 is a perspective view of a containment system in accordance with an embodiment of the present technology;

FIG. 4A is a close up of a segment of a sloped roof portion in accordance with an embodiment of the present technology;

FIG. 4B is a close up of a segment of a sloped roof portion in accordance with an embodiment of the present technology; and

FIG. 5 is a flowchart illustrating a method of insulating a body of heated material in accordance with an embodiment of the present invention.

These drawings are provided to illustrate various aspects of the invention and are not intended to be limiting of the scope in terms of dimensions, materials, configurations, arrangements or proportions unless otherwise limited by the claims.

### DETAILED DESCRIPTION

While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only and not limitation to describe the features and characteristics of the present invention, to set forth the best mode of operation of the invention, and to sufficiently enable one skilled in the art to practice the invention. Accordingly, the scope of the present invention is to be defined solely by the appended claims.

### DEFINITIONS

In describing and claiming the present invention, the following terminology will be used.

As used herein, “hydrocarbonaceous material” refers to any hydrocarbon-containing material from which hydrocarbon products can be extracted or derived. For example, hydrocarbons may be extracted directly as a liquid, removed via solvent extraction, directly vaporized, by conversion from a feedstock material, or otherwise removed from the material. Many hydrocarbonaceous materials contain kerogen or bitumen which is converted to a flowable or recoverable hydrocarbon through heating and pyrolysis. Hydrocarbonaceous materials can include, but are not limited to, oil shale, tar sands, coal, lignite, bitumen, peat, and other organic rich rock. Thus, existing hydrocarbon-containing materials can be upgraded and/or released from such feedstock through a chemical conversion into more useful hydrocarbon products.

As used herein, “spent hydrocarbonaceous material” and “spent oil shale” refer to materials that have already been used to produce hydrocarbons. Typically after producing hydrocarbons from a hydrocarbonaceous material, the remaining material is mostly mineral with the organic content removed. However, some amount of the original organic content can remain in the spent material, such as less than about 10%, less than about 20%, or less than about 30% of the original organic content.

As used herein, “lean hydrocarbonaceous material” and “lean oil shale” refer to materials that have a relatively low hydrocarbon content. As an example, lean oil shale can typically have from 1% to 8% hydrocarbon content by weight.

As used herein, “rich hydrocarbonaceous material” and “rich oil shale” refer to materials that have a relatively high hydrocarbon content. As an example, rich oil shale can typically have from 12% to 25% hydrocarbon content by weight, and some cases higher.

As used herein, “compacted earthen material” refers to particulate materials such as soil, sand, gravel, crushed rock, clay, spent shale, mixtures of these materials, and similar materials. A compacted earthen material suitable for use in the present invention typically has a particle size of less than about 10 cm in diameter.

As used herein, “conduits” refers to any passageway along a specified distance that can be used to transport materials and/or heat from one point to another point. Although conduits can generally be circular conduits, other non-circular conduits can also be useful. Conduits can advantageously be used to introduce fluids into and/or extract fluids from the capsule, and to heat the material inside the capsule.

As used herein, “wall”, “walls”, “sidewall” or “sidewalls” refer to a constructed continuous multilayered wall defining at least a portion of the capsule. Walls are typically vertical but can be oriented in any functional manner. Ceilings, floors and other contours and portions of the system defining the capsule can also be “walls” as used herein unless otherwise specified.

As used herein “floor” refers to the bottom of the capsule upon which the wall or sidewall rests or is secured. The floor portion of the capsule is generally contiguous with the wall portions.

As used herein the terms “cap”, “wall” and “floor” are used for convenience in describing positioning in the capsule but the various layers forming the cap, wall and floor can be one continuous layer.

As used herein, whenever any property is referred to that can have a distribution between differing values, such as a temperature distribution, particle size distribution, etc., the property being referred to represents an average of the distribution unless otherwise specified. Therefore, “particle size” refers to an average particle size, and so on.

It is noted that, as used in this specification and in the appended claims, the singular forms “a,” “an,” and “the” include plural referents unless the context clearly dictates otherwise. Thus, for example, reference to “a layer” includes one or more of such features, reference to “a particle” includes reference to one or more of such elements, and reference to “producing” includes reference to one or more of such steps.

As used herein, the terms “about” and “approximately” are used to provide flexibility, such as to indicate, for example, that a given value in a numerical range endpoint may be “a little above” or “a little below” the endpoint. The degree of flexibility for a particular variable can be readily determined by one skilled in the art based on the context.

As used herein, the term “substantially” refers to the complete or nearly complete extent or degree of an action, characteristic, property, state, structure, item, or result. The exact allowable degree of deviation from absolute completeness may in some cases depend on the specific context. However, the nearness of completion will generally be so as to have the same overall result as if absolute and total completion were obtained. “Substantially” refers to a degree of deviation that is sufficiently small so as to not measurably detract from the identified property or circumstance. The exact degree of deviation allowable may in some cases depend on the specific context. The use of “substantially” is equally applicable when used in a negative connotation to refer to the complete or near complete lack of an action, characteristic, property, state, structure, item, or result.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context. Additionally, adjacent structures or elements can in some cases be separated by additional structures or elements between the adjacent structures or elements.

As used herein, the term “at least one of” is intended to be synonymous with “one or more of” For example, “at least one of A, B and C” explicitly includes only A, only B, only C, and combinations of each (e.g. A+B, B+C, A+C, and A+B+C).

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a numerical range of about 1 to about 4.5 should be interpreted to include not only the explicitly recited limits of 1 to about 4.5, but also to include individual numerals such as 2, 3, 4, and sub-ranges such as 1 to 3, 2 to 4, etc. The same principle applies to ranges reciting only one numerical value, such as “less than about 4.5,” which should be interpreted to include all of the above-recited values and ranges. Further, such an interpretation should apply regardless of the breadth of the range or the characteristic being described.

Any steps recited in any method or process claims may be executed in any order and are not limited to the order presented in the claims. Means-plus-function or step-plus-function limitations will only be employed where for a specific claim limitation all of the following conditions are present in that limitation: a) “means for” or “step for” is expressly recited; and b) a corresponding function is expressly recited. The structure, material or acts that support the means-plus function are expressly recited in the description herein. Accordingly, the scope of the invention should be determined solely by the appended claims and their legal equivalents, rather than by the descriptions and examples given herein.

Reference will now be made to the exemplary embodiments illustrated, and specific language will be used herein to describe the same. It will nevertheless be understood that no limitation of the scope of the technology is thereby intended. Additional features and advantages of the technology will be apparent from the detailed description which follows, taken in conjunction with the accompanying drawings, which together illustrate, by way of example, features of the technology.

With the general examples set forth in the Summary above, it is noted in the present disclosure that when describing the system, or the related devices or methods, individual or separate descriptions are considered applicable to one other, whether or not explicitly discussed in the context of a particular example or embodiment. For example, in discussing a device per se, other device, system, and/or method embodiments are also included in such discussions, and vice versa.

Furthermore, various modifications and combinations can be derived from the present disclosure and illustrations, and as such, the following figures should not be considered limiting.

Containment Systems and Methods with Reduced Friction

The present technology provides systems and methods for containing subsiding materials. The systems and methods use a plurality of geosynthetic layers to reduce friction on a sloped roof or cap over the subsiding material, which in turn reduces the shear stress on the roof or cap. An exemplary embodiment will be described to demonstrate the utility of the present technology. In one specific embodiment, a capsule can be formed to contain crushed oil shale. The capsule can be a substantially fluid-tight barrier surrounding the oil shale. The floor, walls, and roof of the capsule can include hydrated clay to make the capsule impermeable to fluids. Liquid and gaseous hydrocarbons can be produced from the oil shale by heating the oil shale inside the capsule.

In this embodiment, the roof of the capsule can be supported by the crushed oil shale inside the capsule. The capsule can be formed from mostly earthen materials, such as clay, gravel, crushed rock, and so forth. Because these materials do not have a great amount of structural strength on their own, the roof derives most of its support from the crushed oil shale, except at the periphery where the roof is supported by the sidewalls of the capsule.

As hydrocarbons are extracted from the crushed oil shale over time, the oil shale can begin to subside. Individual particles of oil shale can decrease in volume as hydrocarbons are extracted. In some cases, the body of oil shale can subside to such a degree that the height of the body of oil shale drops by 10-40%. As the height of the oil shale drops, the roof loses its support, and the roof can collapse. If the roof was formed as a flat layer across the top of the body of oil shale, the roof can tend to become concave as the center of the roof collapses down while the peripheral edges of the roof are supported by the sidewalls of the capsule. In some cases, oil shale can tend to subside more in the center of the capsule than at the edges. This can also contribute to the center of the roof dropping lower that the edges. When the roof becomes concave, the layer of hydrated clay in the roof is subjected to tensile stress. Despite some degree of pliability and conformability, the hydrated clay does not have a high tensile strength. Therefore, when the layer is subjected to tensile stress, the clay tends to crack and break. One function of the hydrated clay layer is to form a fluid-tight barrier to contain liquid and gaseous hydrocarbons inside the capsule. If cracks form in the roof of the capsule, then the capsule is no longer fluid-tight and the hydrocarbons inside can escape. This wastes valuable hydrocarbon products, as well as contaminates the environment. Furthermore, such breaches in the barrier can make it difficult to recover additional hydrocarbon content in the oil shale.

The roof of the capsule can be preemptively formed with sloping sections, so that the roof generally bulges upward. This can allow the roof to drop down as the oil shale subsides without the roof becoming concave. For example, the body of oil shale can be formed with a rounded top, so that the roof being supported by the oil shale has a rounded shape. Because the oil shale tends to subside more in the center than at the edges, the center of the roof drops down more than the edges, and the rounded shape flattens out as the oil shale subsides. As the roof flattens, the hydrated clay layer is subjected to compressive stress. Unlike tensile stress, compressive stress does not make the clay more likely to crack. In fact, compressive stress can in some cases increase the impermeability of the clay.

However, forming the roof with sloped portions that make the roof bulge upward is not always sufficient to prevent cracking in the hydrated clay layer. As the roof drops down, the sloped portions of the roof become less steeply sloped. In some cases this continues until the sloped portions are substantially flat. The motion of shifting from sloped to flat places shear stress on the hydrated clay layer. The shear stress is worsened by other materials that may be adjacent to the clay layer. For example, the clay layer can be in contact with the body of oil shale on the bottom surface of the clay layer. In some cases, the clay layer can be in contact with an insulating layer made of gravel or crushed spent oil shale on the bottom surface of the clay layer. The top surface of the clay layer can be covered with additional material such as topsoil. As the sloped portion of the roof shifts to become more flat, friction at the interfaces between the clay layer and the materials above and below can force the top and bottom surfaces of the clay layer to shear in opposite directions. The resulting shear stress in the clay layer can cause the clay to buckle, crack, or break apart. This can lead to loss of hydrocarbons from the capsule and the other problems described above.

Accordingly, the present technology also includes a plurality of geosynthetic layers to reduce friction on the sloped portions of the roof. The plurality of geosynthetic layers can generally include at least two sheets of geosynthetic material such as geotextiles or geomembranes. In one example, the plurality of geosynthetic layers can be a double geosynthetic layer (i.e. two adjacent contacting sheets of geosynthetic material), but any suitable number of layers can be used. In one example, the double geosynthetic layer can be placed at the interface between the clay layer and adjacent material, such as an insulating gravel layer on the inside of the capsule. When the sloped portion of the roof flattens, the two sheets of geosynthetic material can slide in opposite directions or at different rates relative to one another, thereby reducing the force of friction exerted on the clay layer. In another example, a plurality of geosynthetic layers, such as a double geosynthetic layer, can be applied to each of the bottom and top surfaces of the clay layer, so that both surfaces of the clay have reduced friction. Thus, the shear stress on the clay layer is reduced and the clay layer can be prevented from cracking. A plurality of geosynthetic layers can also be added at various depths within the clay layer itself. Adding more geosynthetic layers or pluralities of geosynthetic layers can further reduce the shear stress in the clay layer.

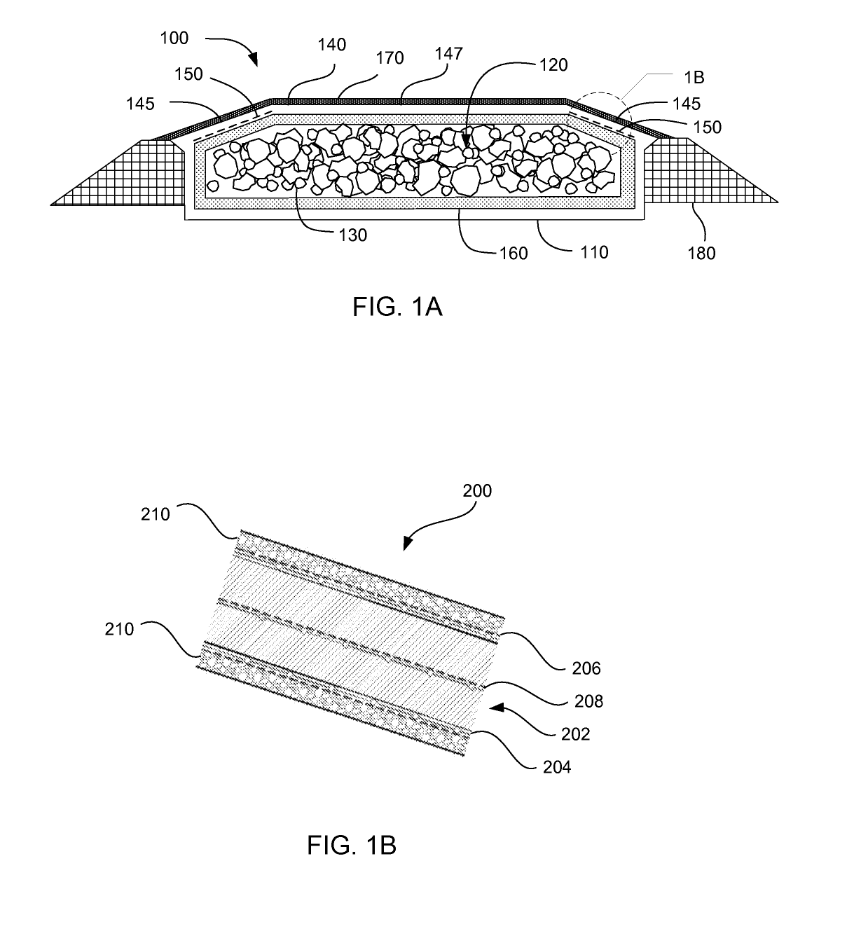

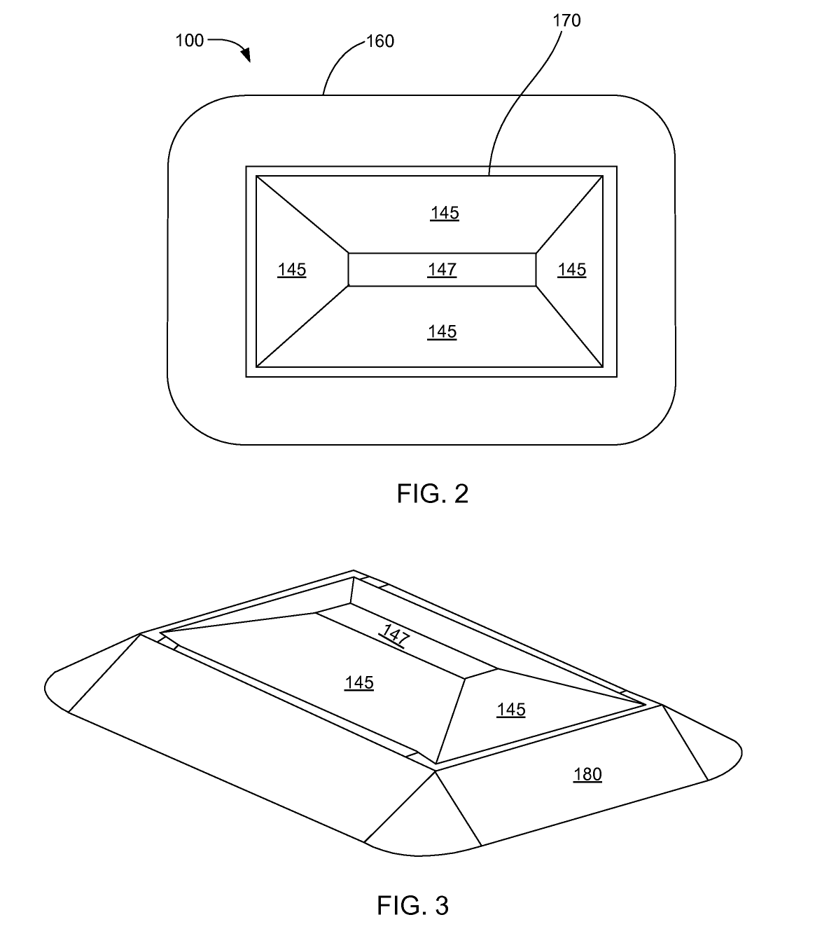

With this description in mind, FIG. 1A shows a containment system 100 in accordance with an embodiment of the present technology. The system includes a capsule 110 surrounding a porous volume 120. A porous solid material 130 subject to subsidence is oriented within the capsule. The porous solid material supports the roof 140 of the capsule. The roof has sloped roof portions 145 sloping upward from peripheral edges of the roof. The sloped roof portions are configured to decrease in slope as the solid material within the capsule subsides. A plurality of geosynthetic layers 150 is placed along at least the sloped roof portions. In the embodiment shown, the system also includes an insulating layer 160, a layer of cover soil 170, and containment berms 180 supporting sidewalls of the capsule.

In some embodiments, the capsule can comprise a floor, sidewalls, and a roof. The floor can be a substantially horizontal layer at the bottom of the capsule. In some cases, the floor can be supported by existing surface topography in the location where the capsule is constructed. For example, the floor can conform to topographical features such as hills, depressions, and so on. When a capsule is constructed on an incline, the floor can follow the same incline. Alternatively, the existing topography can be smoothed out to allow for a smoother floor. In one embodiment, the floor can be sloped toward a drain to allow drainage of liquids inside the capsule.

In some embodiments, a pit can be excavated and the floor of the capsule can be formed in the pit. Thus, the floor can be supported by the bottom and walls of the pit. In one embodiment, the pit can be excavated in a solid rock formation, so that the floor is supported by exposed undisturbed formation on interior surfaces of the excavated pit. The pit can be excavated to depths from about 1 m to about 10 m deep. Depending on the thickness of the floor of the capsule, the floor can be entirely below grade, approximately even with the existing grade, or above grade. Additionally, the floor can be supported by other support materials, such as geogrids or geomembranes.

The floor is not necessarily a separate piece from the sidewalls and roof of the capsule. The floor, sidewalls, and roof can all be portions of a continuous layer. The floor can generally be defined as the bottom face of the capsule that is supported by earth or formation beneath the capsule. Sidewalls can extend upward from the perimeter of the floor and connect to the roof at the top of the capsule. In some embodiments, the sidewalls can be substantially vertical. In other embodiments, the sidewalls can be sloped.

As shown in FIG. 1A, the capsule 110 can have sidewalls that extend upward from the floor and are at least partially supported on an exterior face of the sidewalls by containment berms 180. The containment berms can extend around the perimeter of the capsule, as shown in FIG. 2. The containment berms can be built up of earthen materials. For example, containment berms can comprise gravel, crushed rock, boulders, crushed spent oil shale, crushed lean oil shale, tailings, compacted earth, gabions, and other earthen materials. Containment berms can also contain geomembranes, woven textiles, non-woven textiles, geogrids, and other supporting material. In alternative embodiments, the capsule can be constructed in an excavated pit and the sidewalls can be supported by walls of the pit instead of by containment berms.

The sidewalls can be supported on the interior of the capsule by materials within the capsule. In the embodiment shown in FIG. 1A, the sidewalls are supported on the interior of the capsule by a layer of insulating material 160. The sidewalls can also be supported by other particulate materials within the capsule.

The roof of the capsule can be substantially supported by materials within the capsule. FIG. 1A shows the roof 140 supported by a layer of insulating material 160. The roof can include sloped roof portions 145. These sloped roof portions are also shown in FIGS. 2 and 3. These sloped portions can rise up from the sidewalls of the capsule and terminate at a central crown portion 147. This configuration of the roof allows the roof to flatten somewhat during subsidence of the materials within the capsule.

The capsule can be constructed using any suitable approach. However, in one aspect, the capsule is formed from the floor up. The formation of the walls, containment berms, and filling the interior of the capsule with particulate material can be accomplished simultaneously in a vertical deposition process where materials are deposited in a predetermined pattern. For example, multiple chutes or other particulate delivery mechanisms can be oriented along corresponding locations above the deposited material. By selectively controlling the volume of particulate delivered and the location along the aerial view of the system where each respective particulate material is delivered, the layers and structure can be formed simultaneously from the floor to the ceiling. The sidewall portions of the capsule can be formed as a continuous upward extension at the outer perimeter of the floor and each layer present, including any particulate material in the interior of the capsule, an insulating layer if present, the gas containment barrier, and containment berms, are constructed as a continuous extension of the floor counterparts. During the building up of the sidewalls, particulate material can be simultaneously placed on the floor and within the sidewall perimeter such that, what will become the enclosed volume, is being filled simultaneously with the rising of the constructed sidewall. In this manner, internal retaining walls or other lateral restraining considerations can be avoided. This approach can also be monitored during vertical build-up in order to verify that intermixing at interfaces of layers is within acceptable predetermined tolerances (e.g. maintain functionality of the respective layer). For example, excessive intermingling of the gas barrier layer with the insulating material in the insulating layer may compromise the sealing function of the gas barrier layer. This can be avoided by careful deposition of each adjacent layer as it is built up and/or by increasing deposited layer thickness. Hydrated materials in the capsule can be deposited dry and then hydrated after the capsule is complete. Alternately, a first horizontal layer of dry material can be deposited, followed by hydrating the layer, and then another layer of dry material can be deposited on top of the first layer, and then hydrated, and so on.

The capsule can comprise a hydrated clay layer. In some embodiments, the hydrated clay layer can include a mixture of a particulate swelling clay with a non-swelling particulate material, and water hydrating the particulate swelling clay and forming a continuous liquid phase in the layer. The hydrated clay layer can be impermeable to fluids including vapors, gases, and liquids. Non-limiting examples of suitable swelling clays for use in forming the hydrated clay layer can include bentonite clay, montmorillonite, kaolinite, illite, chlorite, vermiculite, and others. Non-limiting examples of non-swelling particulate materials can include soil, sand, gravel, crushed rock, crushed spent oil shale, crushed lean oil shale, and others. In one embodiment, the hydrated clay layer can comprise soil amended with a swelling clay. For example, the hydrated clay layer can comprise bentonite amended soil. Bentonite amended soil can be hydrated by adding water, which causes the particles of bentonite to swell. The hydrated bentonite particles and the other particles present in the soil form an impermeable matrix that is an effective barrier to vapors and liquids. In some cases, bentonite amended soil can comprise, by weight, about 5-20% bentonite clay; 15-20% water; and the remainder soil or aggregate. When hydrated, the bentonite component swells to several times the dry volume of the bentonite clay thus sealing the soil such that this material is plastic and malleable. Additional materials that can optionally be included in the capsule can include compacted fill, refractory cement, cement, grout, high temperature asphalt, sheet steel, sheet aluminum, synthetic geogrids, fiberglass, rebar, hydrocarbon additives, filled geotextile bags, polymeric resins, PVC liners, or combinations thereof. For large scale operations forming the capsule from a majority of earthen material can provide an effective barrier.

The capsule can restrict passage of fluids into or out of the capsule. In embodiments involving hydrocarbon extraction, hydrocarbon fluids produced from hydrocarbonaceous material inside the capsule can be retained inside the capsule to avoid contamination of the environment outside the capsule and loss of valuable hydrocarbon products. In some embodiments, the capsule can prevent substantially all passage of hydrocarbons outside the capsule except through designated conduits such as gas and liquid hydrocarbon outlet conduits. Such outlet conduits can include one or more drains in a lower portion of the capsule for draining liquid hydrocarbons, one or more gas outlets in an upper portion of the capsule for withdrawing gases and vapors, one or more intermediate outlets located at intermediate heights within the capsule for withdrawing hydrocarbon liquids and gases with various boiling points, or combinations of these different outlets. Outlet conduits can penetrate through the capsule to allow hydrocarbon products to be collected from the capsule. The capsule walls immediately surrounding the conduit can be sealed against the exterior surfaces of the conduit so that no leakage of hydrocarbons occurs at the interface between the conduit and the capsule.

Additionally, the capsule can restrict passage of air, water, or other fluids into the capsule from the surrounding environment. Leakage of air into the capsule can potentially cause problems with the process of recovering hydrocarbons from hydrocarbonaceous materials. For example, the presence of oxygen can result in polymerization and gumming of the hydrocarbons and other contents within the capsule. Further, the presence of oxygen can induce combustion within the system. In some embodiments, the capsule can prevent substantially all passage of fluids into the capsule from the surrounding environment, with the exception of optionally feeding fluids into the capsule through designated inlet conduits. In some cases inlet conduits can be used to introduce heated gases into the capsule to heat hydrocarbonaceous material within the capsule. In one such example, heating conduits can be used to introduce hot combustion gas into the capsule. Other fluids that can be introduced into the capsule through inlet conduits include, but are not limited to, steam, inert or non-oxidizing gases, solvents, hydrocarbons, catalysts, and so on. Accordingly, the capsule can prevent passage of fluids in either direction, either into or out of the capsule, with the exception of designated inlet and outlet conduits.

The hydrated clay layer can have a thickness sufficient to prevent leakage of fluids into or out of the capsule. In one example, the hydrated clay layer can have a thickness from about 10 cm to about 2 m. In another example, the hydrated clay layer can have a thickness from about 50 cm to about 1 m. Additionally, the capsule can be constructed to any desired size. However, in many embodiments the capsule can be relatively large. In embodiments involving hydrocarbon production, larger capsules or systems with multiple capsules can readily produce hydrocarbon products and performance comparable to or exceeding smaller systems. As an illustration, single capsules can range in size from tens of meters across to tens of acres. Optimal capsule sizes may vary depending on the type of hydrocarbonaceous material inside the capsule and operating parameters, however suitable capsule areas can range from about one-half to ten acres in top plan surface area. Additionally, the capsule can have a depth from about 10 m to about 50 m. In some embodiments, the capsule can define an enclosed volume of 20,500 m³ to 2e6 m³.

Although embodiments have been described for use in production of hydrocarbons from hydrocarbonaceous material, the present technology can be useful in other applications as well. For example, fluids can be recovered from the porous material inside the capsule by any number of processes such as, but not limited to, leaching, solvent extraction (e.g. vapor extraction, liquid extraction), bioremediation, chemical oxidation, thermal oxidation, and the like. These processes can be used to remove pollutants, toxic elements, volatile organics, or other undesirable materials, as well as recover valuable materials such as precious metals or other metals, and chemical precursor materials. Thus, the porous material inside the capsule can include contaminated soil, metal rich ore, municipal waste, and the like. Some of these processes require heating, while others can be performed effectively without heating. Therefore, although some embodiments can include the hydrated clay layer to make the capsule fluid-tight, any additional layers such as the insulating layer or other layers are optional. Additionally, not all embodiments require a fluid-tight hydrated clay layer. In some embodiments, the capsule can be permeable. As an example, in some cases the capsule can be an excavated pit that is filled with a particulate material subject to subsidence. The capsule can comprise a cap covering the particulate material, wherein the cap includes sloped portions that are configured to decrease in slope as the particulate material subsides. Not all embodiments require fluid to be removed from the subsiding material. In some cases, the material inside the capsule can be subject to subsidence simply from settling or rearrangement of particles of the material.

In one aspect, the capsule can be formed along walls of an excavated hydrocarbonaceous material deposit. For example, oil shale, tar sands, or coal can be mined from a deposit to form a cavity that corresponds approximately to a desired encapsulation volume for a capsule. The excavated cavity can then be used as a form and support for the capsule. In an alternative aspect, a berm can be formed around the outside wall surface of the capsule if the capsule is partially or substantially above ground level.

Mining and/or excavation of hydrocarbonaceous deposits, the crushing thereof, and placement within the capsule can be accomplished using any suitable technique.

In some examples, the particulate material inside the capsule can be a hydrocarbonaceous material. Examples of hydrocarbonaceous material include, but are not limited to, oil shale, tar sands, lignite, bitumen, coal, peat, harvested biomass, and any other hydrocarbon rich material. Many of these materials are characterized by the ability to produce liquid and gaseous hydrocarbons by heating the materials to elevated temperatures. For example, oil shale can be heated to temperatures sufficient to pyrolize kerogen in the oil shale, which breaks down the kerogen into liquid and gaseous hydrocarbons with lower molecular weights. The operating temperature for producing hydrocarbons can be selected depending on the type of hydrocarbonaceous material, the desired molecular weight of hydrocarbon products, the desired phase (liquid or vapor) of hydrocarbon products, and the desired rate of production of hydrocarbon products. For example, lower temperatures can be applied for longer periods of time, or higher temperatures can be applied for shorter periods of time. In some embodiments, the temperature of hydrocarbon production can be from about 95° C. to about 500° C., and in other aspects from 100° C. to 400° C., and others from 200° C. to 300° C.

In some embodiments, the combined layers forming the capsule can serve to insulate the capsule such that heat within the enclosed volume is retained to facilitate the removal of hydrocarbons from hydrocarbonaceous materials. An insulating layer can provide a temperature gradient across the layer that allows the hydrated clay layer to be cool enough to remain hydrated. When utilized, the insulative layer can most often be formed of a fines layer. Typically, the fines layer can be a particulate material of less than 2″ in diameter. Although other materials may be suitable, the fines layer can typically be made up of gravel, sand, crushed lean oil shale or other particulate fines which do not trap or otherwise inhibit fluid flow through the insulative layer. By choosing appropriate particulate materials and layer thickness the fines layer can act as the principal source of insulation. The inner surface of the fines layer, adjacent to the oil shale being roasted is at the temperature of the roasting process. The outer surface of the fines layer, adjacent to the hydrated clay layer, remains cool enough, below the boiling point of water, to preserve the hydration of the hydrated clay layer. As such, there is a substantial thermal gradient across the fines layer towards the outer surface of the fines layer. Gases produced during the roasting process penetrate this permeable fines layer. As these gases cool sufficiently in the fines layer (below the condensation point of the corresponding gases), liquids can condense from the gases. These liquids are largely hydrocarbons, which do not substantially wet the fines, and subsequently trickle down through the fines to the bottom of the capsule, where they can be collected and removed.

Additionally, the fines layer can serve as a filter to remove suspended particulates present in the hydrocarbons as the collected hydrocarbons are condensed and resulting liquids pass downward through the fines layer for collection and removal from the infrastructure. Such suspended particulates are attracted and adhere to the surface of the fines particles resulting in collected produced hydrocarbons that are free, or essentially free, of suspended particulates. Thus, the hydrocarbons percolate downward through the fines layer with concomitant filtration and removal of a substantial portion of suspended particulates from the hydrocarbons.

The insulating layer can comprise a variety of insulating materials. The insulating material can generally be a material that does not trap or otherwise inhibit fluid flow through the insulating layer. Examples of insulating materials include, but are not limited to, gravel, sand, spent oil shale, open-cell foam, fiberglass, mineral wool, and so on. In one embodiment, the insulating material can be crushed spent oil shale. Other optional insulation materials can include biodegradable insulating materials, e.g. soy insulation and the like. This is consistent with embodiments wherein the impoundment is a single use system such that insulations and other components can have a relatively low useful life, e.g. less than 1-2 years. This can also reduce equipment costs as well as reduce long-term environmental impact.

In hydrocarbon production processes, insulating material can be obtained from materials produced as part of the process. For example, hydrocarbonaceous materials can be mined to use as a feedstock for hydrocarbon production. After producing hydrocarbons from the hydrocarbonaceous material, the spent hydrocarbonaceous material can be crushed and used as insulating material. Additionally, other rock that may be mined along with the hydrocarbonaceous material can be used as the insulating material, or lean hydrocarbonaceous material that would not be profitable to use as feedstock can be used as insulating material.

The heating time for hydrocarbon production can be relatively long. For example, in some examples the heating time can be from about 3 days to about 2 years. In other examples, the heating time can be from about 2 weeks to about 4 months. In embodiments involving production of hydrocarbons from hydrocarbonaceous material, the heating time can be sufficient to recover most of the hydrocarbons from the hydrocarbonaceous material. In one example, the heating time can be sufficient to recover at least 90% of the hydrocarbons from the hydrocarbonaceous material. Long heating times used in conjunction with moderate temperatures can in some cases produce better quality hydrocarbon products than shorter heating times with higher temperatures.

The capsule can be formed using any suitable approach. However, in one aspect, the structure is formed from the floor up. The formation of the wall or walls and filling of the enclosure with the particulate material can be accomplished simultaneously in a vertical deposition process where materials are deposited in a predetermined pattern. For example, multiple chutes or other particulate delivery mechanisms can be oriented along corresponding locations above the deposited material. By selectively controlling the volume of particulate delivered and the location along the aerial view of the system where each respective particulate material is delivered, the layers and structure can be formed simultaneously from the floor to the crown. The sidewall portions of the infrastructure can be formed as a continuous upward extension at the outer perimeter of the floor and each layer present can be constructed as a continuous extension of the floor counterparts. During the building up of the sidewall, the hydrocarbonaceous material can be simultaneously placed on the floor and within the sidewall perimeter such that, what will become the enclosed space, is being filled simultaneously with the rising of the constructed sidewall. In this manner, internal retaining walls or other lateral restraining considerations can be avoided. This approach can also be monitored during vertical build-up in order to verify that intermixing at interfaces of layers is within acceptable predetermined tolerances (e.g. maintain functionality of the respective layer). For example, excessive intermingling of clay with fines may compromise the sealing function of the hydrated clay layer. This can be avoided by careful deposition of each adjacent layer as it is built up and/or by increasing deposited layer thickness.

As the build-up process nears the upper portions, the roof can be formed using the same delivery mechanisms described above and merely adjusting the location and rate of deposition of the appropriate material forming the crown layer. For example, when the desired height of the sidewall is reached, sufficient amount of the particulate material can be added to form a support for the roof. This support can be a rounded pile of particulate material extending above an imaginary horizontal plane that is substantially parallel to surrounding local surface or existing grade and that runs from the tops of the side walls of the containment system. In other words, there will be an overfill of particulate material within the space defined by the inner perimeter of the capsule walls. The volume of the particulate material used to form the roof is referred to as the “roof volume.” Similarly, the volume of space that is circumscribed by floor, sidewalls, and the above-described imaginary horizontal plane can be referred to as the target-volume.

The desired roof volume necessary to prevent excessive subsidence (i.e. subsidence that results in a volume that is less than the target volume) can vary depending on a number of factors. One factor that can affect the desired roof volume is the volume of the containment system. Another factor that can affect the desired crown volume is the nature of the particulate material placed in the sealed containment system. For example, if the sealed containment system includes crushed oil shale the subsidence may be greater than if the particulate material is tar sands. Similarly, oil shale containing large amounts of hydrocarbonaceous material may have greater subsidence than oil shale that has lesser amounts of hydrocarbonaceous material. Similarly, particulate size can affect the degree of subsidence and whether particle size distributions are relatively larger or narrower. Still another factor that can affect the desired roof volume can be the depth of the containment system, i.e. the length of the sidewalls. Deeper containment systems typically require larger roof volumes as compared to shallower containment systems. When the desired overfill is achieved, the roof of the capsule can be completed by the placement of a fines layer and a hydrated clay layer over the particulate material. A plurality of geosynthetic layers can be added to reduce friction on the hydrated clay layer.

As used herein, “plurality of geosynthetic layers” refers to adjacent geosythetic layers that are in direct contact with one another without intervening layers of material, other than an optional lubricant. For example, a “double geosynthetic layer” refers to two adjacent geosynthetic layers that are in direct contact with one another without intervening layers of material between them other than an optional lubricant (e.g. mineral oil, synthetic lubricant, etc). The individual layers need not have the same surface area, but where the individual layers overlap, they are in direct contact with one another and there are no intervening layers of material between any of the individual layers of a given plurality of geosynthetic layers. In one non-limiting example, a first individual layer of a plurality of geosynthetic layers can extend along and interface with an entire inner or outer perimeter of the hydrated clay layer. A second individual layer of the plurality of geosynthetic layers can interface with both a layer of the capsule adjacent to the hydrated clay layer and the first individual layer on opposing surfaces of the second individual layer. The second individual layer of the “plurality of geosynthetic layers can extend along only sloped roof portions of the capsule, can extend along the entire roof portion, can extend along the entire perimeter of the hydrated clay layer, or any other suitable configuration.

Referring now to FIG. 1B, an expanded view of the encircled portion of FIG. 1A is shown. In the embodiment shown in FIG. 1B, a segment 200 of a sloped roof portion includes a hydrated clay layer 202 with a double geosynthetic layer 204 on a bottom surface of the hydrated clay layer 202, a second double geosynthetic layer 206 on a top surface of the hydrated clay layer, and a third double geosynthetic layer 208 in the center of the hydrated clay layer. Granular materials 210 are shown above and below the sloped roof portion. These materials can be, for example, an insulating fines layer below the sloped roof portion and a coversoil layer above the sloped roof portion. Although FIGS. 1A-1B only illustrate the plurality of geosynthetic layers on the sloped portions of the roof, the plurality of geosynthetic layers can optionally extend along the inner and/or outer perimeters and throughout the entire roof portion of the hydrated clay layer. Additionally, the plurality of geosynthetic layers can optionally extend along the inner and/or outer perimeters and throughout the sidewall portion of the hydrated clay layer to reduce shear stress that results from subsidence that occurs along or proximate to the sidewalls. Alternatively, the plurality of geosynthetic layers can extend along the entire inner and/or outer perimeters of the hydrated clay layer within the capsule, as well as at various intermediate depths throughout the entire volume of the hydrated clay layer.

The plurality of geosynthetic layers can comprise two or more geosynthetic layers that laterally slide with respect to one another to reduce shear stress in at least the sloped roof portion during subsidence. Geosynthetic layers can be flat, flexible sheets comprising polymeric materials. For example, geosynthetic layers can include geotextiles, geogrids, geonets, geomembranes, geosynthetic clay liners, geocomposites, and so on. In one embodiment, the geosynthetic layers can be selected from woven textiles, nonwoven textiles, and geomembranes. Specific types of geomembranes can include high-density polyethylene liners, linear low-density polyethylene liners, polyvinyl chloride liners, polypropylene liners, chlorosulfonated polyethylene liners, ethylene propylene diene terpolymer liners, and combinations thereof.

In some embodiments, the plurality of geosynthetic layers can comprise two geosynthetic layers that are each individually selected from woven textiles, nonwoven textiles, and geomembranes. Thus, both geosynthetic layers can be made of the same material, or they can be made of different materials. In various examples, the plurality of geosynthetic layers can be two woven textiles, two nonwoven textiles, or two geomembranes. In other examples, the plurality of geosynthetic layers can be a woven textile paired with a nonwoven textile, a woven textile paired with a geomembrane, or a nonwoven textile paired with a geomembrane. In another example, a plurality of geosynthetic layers can be formed by more than two geosynthetic layers, such as three or more. Where the plurality of geosynthetic layers exceeds two layers, the plurality of geosynthetic layers can include any suitable number of woven textiles, nonwoven textiles, and/or geomembranes can be used. In one example, at least one woven textile can be paired with at least one nonwoven textile and/or at least one geomembrane. In another example, at least one nonwoven textile can be paired with at least one woven textile and/or at least one geomembrane. In another example, at least one geomembrane can be paired with at least one nonwoven textile and at least one woven textile. In one example, a plurality of geosynthetic layers can be formed by a single sheet of geosynthetic material that is folded on top of itself to produce the plurality of layers.

In some embodiments, the sloped roof portion can include an impermeable hydrated clay layer. The hydrated clay layer can be separated from the porous material inside the capsule by a plurality of geosynthetic layers, such as a double geosynthetic layer. Thus, the double geosynthetic layer can be oriented on a lower surface of the hydrated clay layer. In further embodiments, a second double geosynthetic layer can be oriented on an upper surface of the hydrated clay layer. An additional solid material can rest on top of the second double geosynthetic layer. The double geosynthetic layers above and below the hydrated clay layer can reduce friction on the upper and lower surfaces of the hydrated clay layer, thus reducing shear stress in the hydrated clay layer.

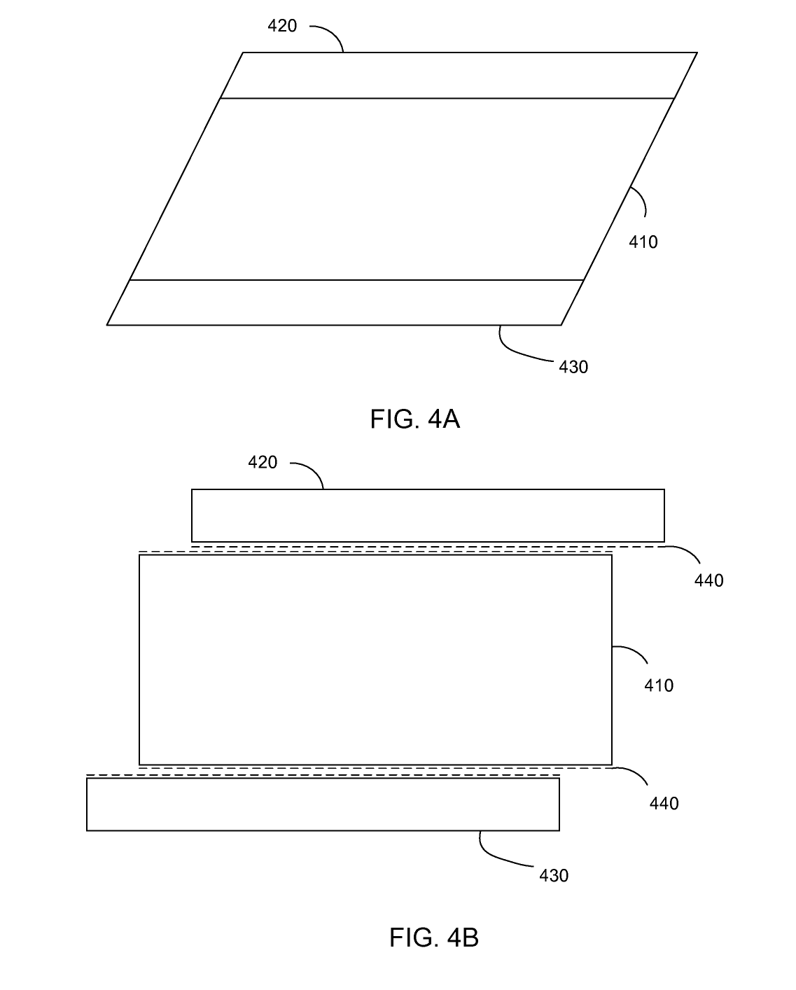

FIG. 4A shows a segment of a sloped roof portion without a plurality of geosynthetic layers after subsidence has occurred. The segment has deformed as the slope decreased. The deformation is caused by shear stress exerted on the hydrated clay layer 410 by the coversoil layer 420 and the insulating layer 430. For comparison, FIG. 4B shows a segment of a sloped roof portion with double geosynthetic layers 440. In this segment, the geosynthetic layers slide against each other so that the hydrated clay layer is not subjected to the same shear stress. Although, FIG. 4B illustrates an embodiment with only two layers, more layers can be used as desired.

The degree of reduction in friction can depend on the types of geosynthetic layers used and the types of materials contacting the geosynthetic layers. For example, in some cases an interface between hydrated clay and a layer of insulating fines or coversoil can have a coefficient of friction from about 0.5 to about 0.7. This coefficient of friction can be reduced by adding a double geosynthetic layer between the hydrated clay and insulating fines or coversoil. In some embodiments, the double geosynthetic layer can have a coefficient of friction from about 0.3 to about 0.5 between two geosynthetic layers that are directly in contact with one another. In further embodiments, the coefficient of friction can be from about 0.35 to about 0.4. Generally, geosynthetic layers can be paired in a way such that the geosynthetic layers have a low coefficient of friction with respect to each other. Because the geosynthetic layers are free to slide with the hydrated clay layer or other layer material to which they are adjacent, the coefficient of friction between the geosynthetic layers and the adjacent materials can be low or high and the double layer can still effectively reduce the overall friction. In another example, an additional geosynthetic layer can be positioned between the two layers included in the double geosynthetic layer to form a triple geosynthetic layer. This additional geosynthetic layer can further decrease the coefficient of friction between the hydrated clay layer and an adjacent layer.

In additional embodiments, the impermeable hydrated clay layer can have a plurality of geosynthetic layers embedded in the clay layer itself. In other words, the hydrated clay layer can be split into two or more sub-layers, with a plurality of geosynthetic layers separating the sub-layers. This plurality of geosynthetic layers can allow the clay sub-layers to slide with respect to one another, further reducing shear stress in the clay sub-layers.

In some examples, the roof of the capsule can comprise a plurality of sloped roof portions sloping upward from peripheral edges of the capsule. For example, in some cases the capsule can be rectangular shaped, such as shown in FIGS. 2 and 3. The sloped roof portions 145 slope upward from peripheral edges of the capsule. The roof can also comprise a central crown portion 147 and the plurality of sloped roof portions can slope upward to terminate at the central crown portion. As the particulate material in the capsule subsides, the sloped roof portions can flatten and the central crown portion can lower. The roof volume can be designed so that the roof is a flat or nearly-flat surface at the final level after subsidence is complete.

In some cases, the roof volume can be calculated based on the expected percent decrease in volume of the particulate material due to subsidence. For example, if the average subsidence of a particular material is known to be 10%, then the roof volume can make up about 10% of the total volume of the capsule. In other cases, a safety factor can be included to ensure that the roof does not drop too far and become concave.

Although various parts of the capsule are referred to herein as “floor,” “sidewall,” “sloped roof portion,” “central crown portion,” etc., the capsule as a whole can comprise a contiguous impermeable hydrated clay layer encapsulating the porous volume to form a fluid-tight barrier. Thus, the various parts of the capsule are not necessarily separate pieces, but in some cases the parts can make up a unified whole.

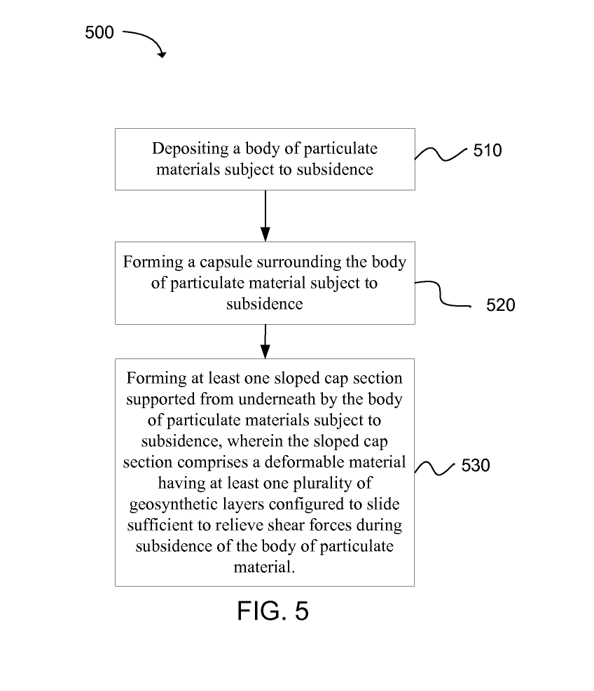

The present technology also relates to methods of reducing shear forces within a containment system for particulate materials subject to subsidence. FIG. 5 is a flowchart illustrating such a method 500. The method includes depositing a body of particulate materials subject to subsidence 510 and forming a capsule surrounding the body of particulate material subject to subsidence 520. Forming the capsule can comprise forming at least one sloped cap section supported from underneath by the body of particulate materials subject to subsidence, wherein the sloped cap section comprises a deformable material having at least one plurality of geosynthetic layers configured to slide sufficient to relieve shear forces during subsidence of the body of particulate material 530. In some embodiments, the deformable material can comprise a hydrated clay.

In further embodiments, forming the at least one sloped cap section can comprise placing a plurality of geosynthetic layers between the deformable material and the body of particulate material. A second plurality of geosynthetic layers can also be placed on an upper surface of the at least one sloped cap section. A layer of soil can be deposited on top of the capsule.

Forming the capsule can comprise forming a contiguous layer of hydrated clay encapsulating the body of particulate material. This can be accomplished by the methods of depositing clay materials and other particulate materials as explained above. In some cases, the particulate material placed inside the capsule can be a hydrocarbonaceous material selected from the group consisting of oil shale, tar sands, coal, lignite, bitumen, peat, harvested biomass, and combinations thereof. In one particular embodiment, the particulate material can comprise oil shale.

In some embodiments, the method can further comprise forming a layer of insulating material along interior surfaces of the capsule. The insulating material can insulate the hydrated clay layer from heat in the body of particulate material if the particulate material is heated. In certain embodiments, the method can include heating the particulate material.

In additional embodiments, the method can include producing a fluid from the body of particulate material and withdrawing the fluid from the capsule. Examples of the fluid include liquid hydrocarbons, gaseous hydrocarbons, water, leachate, solvents, minerals, precious metals, heavy metals, pollutants, and so on. In one embodiment, the particulate material is oil shale, which is heated to produce hydrocarbon products.

The method can also include determining that the at least one sloped cap section has a sufficient slope to prevent cracking of the sloped cap section during subsidence. This can be accomplished by calculated the desired roof volume as explained above. Using a shallower slope, if possible, can often help prevent cracking in the roof. For example, using shallow sloping roof portions that occupy a majority of the top plan surface area of the capsule can be better than using steeply sloping roof portions and a larger flat crown portion in the middle of the roof. Sloped sections can generally have an incline from about 0° to about 45°. In certain embodiments, the sloped sections can have an incline from about 10° to about 30°. In a specific embodiment, the sloped sections can have an incline of about 18°.

The described features, structures, or characteristics may be combined in any suitable manner in one or more examples. In the preceding description numerous specific details were provided, such as examples of various configurations to provide a thorough understanding of examples of the described technology. One skilled in the relevant art will recognize, however, that the technology may be practiced without one or more of the specific details, or with other methods, components, devices, etc. In other instances, well-known structures or operations are not shown or described in detail to avoid obscuring aspects of the technology.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein.

What is claimed is:

1. A containment system comprising:
an capsule surrounding a porous volume; and
a porous solid material subject to subsidence oriented within the capsule and supporting a roof of the capsule;
wherein the roof of the capsule comprises a sloped roof portion configured to decrease in slope as the solid material within the capsule subsides, and wherein the sloped roof portion comprises a plurality of geosynthetic layers oriented along at least portions of the sloped roof portion said plurality of geosynthetic layers including at least two adjacent geosynthetic layers that laterally slide with respect to one another during subsidence to reduce shear forces within the sloped roof portion.

2. The containment system of claim 1, further comprising a fluid retained within the capsule.

3. The containment system of claim 1, wherein the roof of the capsule comprises an impermeable hydrated clay layer.

4. The containment system of claim 3, wherein the plurality of geosynthetic layers separates the impermeable hydrated clay layer from the porous material subject to subsidence.

5. The containment system of claim 4, wherein the roof of the capsule further comprises a second plurality of geosynthetic layers on an upper surface of the impermeable hydrated clay layer and an additional solid material resting on top of the second plurality of geosynthetic layers.

6. The containment system of claim 5, wherein the impermeable hydrated clay layer comprises two impermeable hydrated clay sub-layers separated by a third plurality of geosynthetic layers oriented between the sub-layers.

7. The containment system of claim 3, wherein the plurality of geosynthetic layers is oriented within the hydrated clay layer.

8. The containment system of claim 1, wherein the roof of the capsule comprises a plurality of sloped roof portions sloping upward from peripheral edges of the capsule.

9. The containment system of claim 8, wherein the roof further comprises a central crown portion and the plurality of sloped roof portions slope upward to terminate at the central crown portion.

10. The containment system of claim 1, wherein the capsule comprises a contiguous impermeable hydrated clay layer encapsulating the porous volume to form a fluid-tight barrier.

11. The containment system of claim 1, wherein the adjacent geosynthetic layers are independently selected from woven geotextiles, nonwoven geotextiles, and geomembranes.

12. The containment system of claim 1, wherein the plurality of geosynthetic layers is a double geosynthetic layer.

13. The containment system of claim 12, wherein the double geosynthetic layer has a coefficient of friction from about 0.3 to about 0.5 between the two adjacent geosynthetic layers which are also in direct contact with one another.

14. The containment system of claim 1, wherein the porous solid material within the capsule comprises a hydrocarbonaceous material selected from the group consisting of oil shale, tar sands, coal, lignite, bitumen, peat, harvested biomass, and combinations thereof.

15. The containment system of claim 1, wherein the porous solid material within the capsule comprises oil shale.

16. The containment system of claim 1, wherein the porous solid material within the capsule comprises a layer of insulating material oriented along interior surfaces of the capsule.

17. The containment system of claim 1, further comprising conduits embedded within the porous solid material within the capsule, wherein the conduits are selected from the group consisting of heating conduits, fluid injection conduits, fluid withdrawal conduits, and combinations thereof.

18. A method of reducing shear forces within a containment system for particulate materials subject to subsidence, comprising:
depositing a body of particulate materials subject to subsidence; and
forming a capsule surrounding the body of particulate material subject to subsidence, wherein forming the capsule comprises:
forming at least one sloped cap section supported from underneath by the body of particulate materials subject to subsidence, wherein the sloped cap section comprises a deformable material having at least one plurality of geosynthetic layers configured to slide sufficient to relieve shear forces during subsidence of the body of particulate material.

19. The method of claim 18, wherein forming the at least one sloped cap section comprises placing a plurality of geosynthetic layers between the deformable material and the body of particulate material.

20. The method of claim 19, wherein forming the at least one sloped cap section comprises placing a second plurality of geosynthetic layers on an upper surface of the at least one sloped cap section.

21. The method of claim 18, further comprising depositing a layer of soil on top of the capsule.

22. The method of claim 18, wherein the at least one plurality of geosynthetic layers comprises two adjacent geosynthetic layers that laterally slide with respect to one another during subsidence.

23. The method of claim 22, wherein the two adjacent geosynthetic layers are independently selected from woven geotextiles, nonwoven geotextiles, and geomembranes.

24. The method of claim 22, wherein the at least one double geosynthetic layer has a coefficient of friction from about 0.3 to about 0.5 between the two adjacent geosynthetic layers.

25. The method of claim 18, wherein the deformable material comprises a hydrated clay.

26. The method of claim 18, wherein forming the capsule comprising forming a contiguous layer of hydrated clay encapsulating the body of particulate material.

27. The method of claim 18, wherein the body of particulate materials comprises a hydro carbonaceous material selected from the group consisting of oil shale, tar sands, coal, lignite, bitumen, peat, harvested biomass, and combinations thereof.

28. The method of claim 18, wherein the body of particulate materials comprises oil shale.

29. The method of claim 18, further comprising forming a layer of insulating material along interior surfaces of the capsule.

30. The method of claim 18, further comprising heating the body of particulate material.

31. The method of claim 18, further comprising producing a fluid from the body of particulate material and withdrawing the fluid from the capsule.

32. The method of claim 18, further comprising determining that the at least one sloped cap section has a sufficient slope to prevent cracking of the sloped cap section during subsidence.
